(19) United States
(12) Patent Application Publication
(10) Pub. No.: US 2013/0198690 A1
(43) Pub. Date: Aug. 1, 2013

(54) VISUAL INDICATION OF GRAPHICAL USER INTERFACE RELATIONSHIP

(71) Applicants: Emad N. Barsoum, Bellevue, WA (US); Chad W. Wahlin, Issaquah, WA (US)

(72) Inventors: Emad N. Barsoum, Bellevue, WA (US); Chad W. Wahlin, Issaquah, WA (US)

(73) Assignee: MICROSOFT CORPORATION, Redmond, WA (US)

(21) Appl. No.: 13/363,689

(22) Filed: Feb. 1, 2012

(51) Int. Cl. G06F 3/048

(52) U.S. Cl. 715/822; 715/863

(57) ABSTRACT

Techniques for providing a visual indication of graphical user interface (GUI) relationship are described. In implementations, a layered GUI structure is provided that enables a user to navigate through multiple different GUIs while maintaining their navigation context within the overall GUI structure. Embodiments include techniques for gesture-based navigation of GUIs. Further to such embodiments, a specific gesture can cause navigation to a particular GUI. For example, with reference to menu GUIs, a specific gesture can cause navigation through multiple menu GUIs (e.g., sub-menu GUIs) to a particular menu GUI.

### BACKGROUND

Many computing applications include graphical user interfaces (GUIs) that enable users to access functionalities and customize aspects of the applications. For example, a game application typically includes menu GUIs that enable a user to access different types of gameplay and to customize various game attributes. Navigating existing GUI configurations, however, can present a user with a number of challenges. For example, existing ways of navigating from a main GUI through multiple sub-GUIs can be confusing and can cause a user to lose their context within a GUI/sub-GUI structure. Further, navigating through such a GUI structure to reach a desired GUI can be tedious. For instance, navigating to a desired sub-GUI can involve the selection of multiple buttons across multiple different GUIs to reach the desired sub-GUI.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for providing a visual indication of graphical user interface (GUI) relationship are described. In implementations, a layered GUI structure is provided that enables a user to navigate through multiple different GUIs while maintaining their navigation context within the overall GUI structure. For example, as a user navigates through multiple GUIs, the GUIs can be visually stacked according to an order in which they are navigated to provide a visual indication of the navigation order. Visually stacking the GUIs can include overlaying a more recently navigated GUI over top of a previously navigated GUI. Further, a previously navigated GUI can be reduced in size and/or visually obscured to provide an indication that the previously navigated GUI is not currently in focus in a GUI navigation experience.

Embodiments include techniques for gesture-based navigation of GUIs. A gesture can include touchless input, such as movement by a user of one or more body parts that is sensed by a camera. A gesture can also include touch input, such as input to a touchscreen provided by a user's finger, a stylus, or other suitable touch-based input mechanism. Further to such embodiments, a specific gesture can cause navigation to a particular GUI. For example, with reference to menu GUIs, a specific gesture can cause navigation through multiple menu GUIs (e.g., sub-menu GUIs) to a particular menu GUI. Implementations also enable custom gestures to be associated with specific GUIs. For example, an application developer can specify different gestures that a user can provide to cause navigation to different application GUIs. In implementations, such gestures can also be user-configurable such that a user can associate specific gestures with specific GUI locations.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario in accordance with one or more embodiments.

FIG. 3 illustrates an example implementation scenario in accordance with one or more embodiments.

FIG. 4 illustrates an example implementation scenario in accordance with one or more embodiments.

FIG. 5 is a flow diagram that describes steps in a method in accordance with one or more embodiments.

FIG. 6 illustrates an example implementation scenario in accordance with one or more embodiments.

FIG. 7 illustrates an example implementation scenario in accordance with one or more embodiments.

FIG. 8 illustrates an example implementation scenario in accordance with one or more embodiments.

FIG. 9 is a flow diagram that describes steps in a method in accordance with one or more embodiments.

FIG. 10 is a flow diagram that describes steps in a method in accordance with one or more embodiments.

FIG. 11 illustrates an example system and computing device as described with reference to FIG. 1, which are configured to implement embodiments of techniques described herein.

### DETAILED DESCRIPTION

Overview

Techniques for providing a visual indication of graphical user interface (GUI) relationship are described. In implementations, a layered GUI structure is provided that enables a user to navigate through multiple different GUIs while maintaining their navigation context within the overall GUI structure. For example, as a user navigates through multiple GUIs, the GUIs can be visually stacked according to an order in which they are navigated to provide a visual indication of the navigation order. Visually stacking the GUIs can include overlaying a more recently navigated GUI over top of a previously navigated GUI. Further, a previously navigated GUI can be reduced in size and/or visually obscured to provide an indication that the previously navigated GUI is not currently in focus in a GUI navigation experience.

Embodiments include techniques for gesture-based navigation of GUIs. A gesture can include touchless input, such as movement by a user of one or more body parts that is sensed by a camera. A gesture can also include touch input, such as input to a touchscreen provided by a user's finger, a stylus, or any other suitable touch-based input mechanism. Further to such embodiments, a specific gesture can cause navigation to a particular GUI. For example, with reference to menu GUIs, a specific gesture can cause navigation through multiple menu GUIs (e.g., submenu GUIs) to a particular menu GUI. Implementations also enable custom gestures to be associated with specific GUIs. For example, an application developer can specify different gestures that a user can provide to cause navigation to different application GUIs. In implementations, such gestures can also be user-configurable such that a user can associate specific gestures with specific GUI locations.

In the following discussion, an example environment is first described that is operable to employ techniques for providing a visual indication of GUI relationship described herein. Next, a section entitled “Layered GUI Structures” describes example implementations of some layered GUI structures in accordance with one or more embodiments. Following this, a section entitled “Gesture-Based GUI Navigation” describes example implementations for gesture-based and/or pose-based GUI navigation in accordance with one or more embodiments. Finally, an example system and device are described that are operable to employ techniques discussed herein in accordance with one or more embodiments.

Example Environment

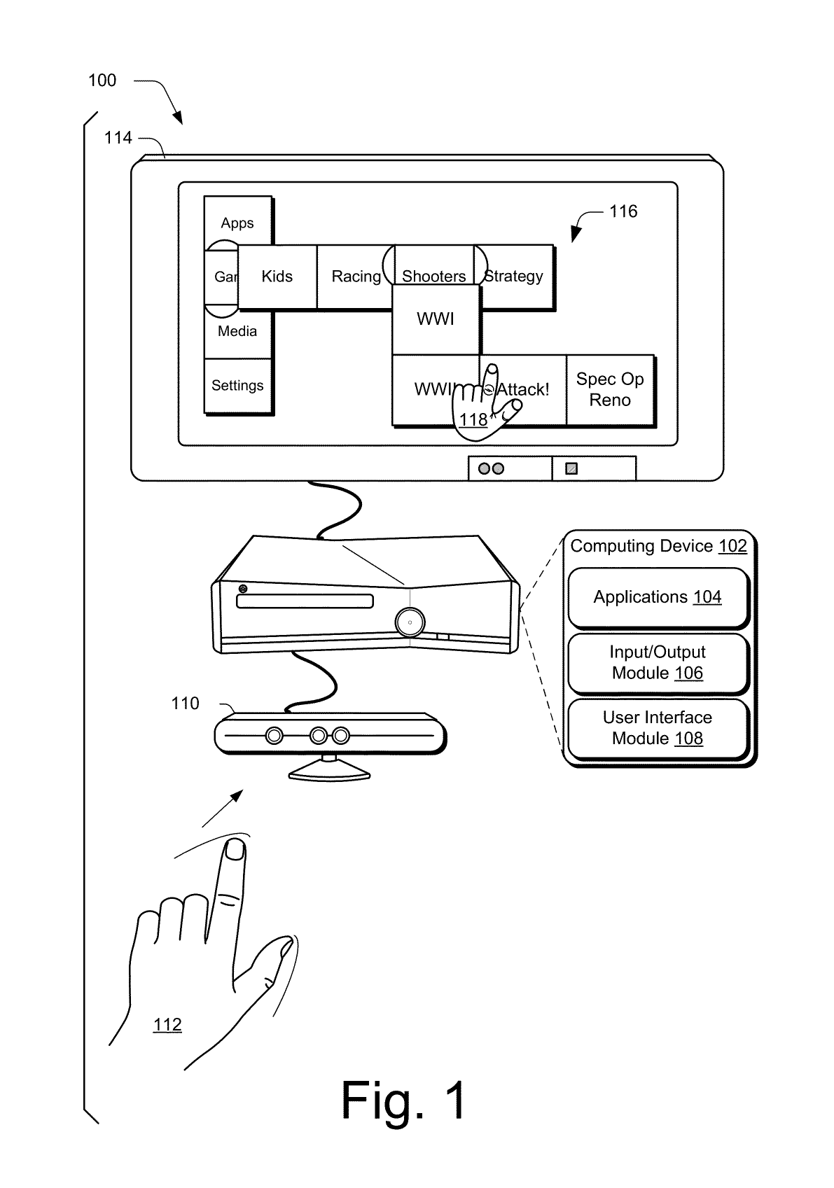

FIG. 1 is an illustration of an environment 100 in an example implementation that is operable to implement techniques for providing a visual indication of GUI relationship discussed herein. The illustrated environment 100 includes a computing device 102, which may be configured in a variety of ways. For example, although the computing device 102 is illustrated as a game console, the computing device 102 may be configured in a variety of other ways. For instance, the computing device 102 may be configured as a computer that is capable of communicating over a network, such as a desktop computer, a mobile station, an entertainment appliance, a set-top box communicatively coupled to a display device, a mobile communication device (e.g., tablet, wireless telephone), and so forth.

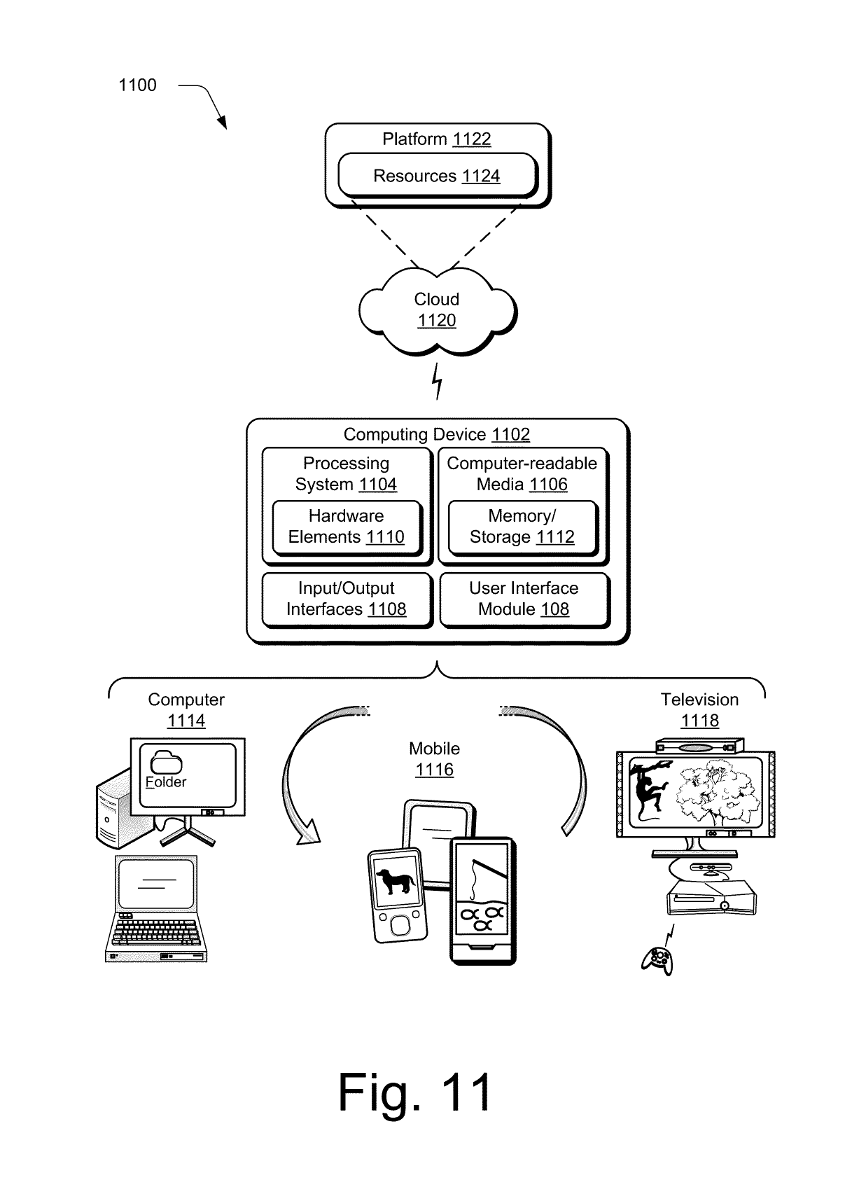

Accordingly, the computing device 102 may range from full resource devices with substantial memory and processor resources (e.g., personal computers, game consoles) to low-resource devices with limited memory and/or processing resources (e.g., traditional set-top boxes, hand-held game consoles). Additionally, although a single computing device 102 is shown, the computing device 102 may be representative of a plurality of different devices, such as a user-wearable helmet and game console, multiple servers utilized by a business to perform operations that provide a platform “in the cloud,” a remote control and set-top box combination, and so on. One of a variety of different examples of a computing device 102 is shown and described below in FIG. 11.

Included as part of the computing device 102 are one or more applications 104, which are representative of functionality to perform various tasks via the computing device 102. For example, one or more of the applications 104 can be configured to implement word processing, games, spreadsheets, email, messaging, and so on.

The computing device 102 further includes an input/output module 106 and a user interface module 108. The input/output module 106 represents functionality for sending and receiving information. For example, the input/output module 106 can be configured to receive input generated by an input device, such as a keyboard, a mouse, a touchpad, a game controller, an optical scanner, and so on. The input/output module 106 can also be configured to receive and/or interpret input received via a touchless mechanism, such as via voice recognition, gesture-based input, object scanning, and so on. The user interface module 108 is representative of functionality to generate and/or manage user interfaces (e.g., GUIs) for various entities, such as the applications 104.

Further included as part of the computing device 102 is a natural user interface (NUI) device 110, which is configured to receive a variety of touchless input, such as via visual recognition of human gestures, object scanning, voice recognition, color recognition, and so on. In at least some embodiments, the NUI device 110 is configured to recognize gestures, objects, images, and so on via cameras. An example camera, for instance, can be configured with lenses, light sources, and/or light sensors such that a variety of different phenomena can be observed and captured as input. For example, the camera can be configured to sense movement in a variety of dimensions, such as vertical movement, horizontal movement, and forward and backward movement, e.g., relative to the NUI device 110. Thus, in at least some embodiments, the NUI device 110 can capture information about image composition, movement, and/or position. The input/output module 106 can utilize this information to perform a variety of different tasks.

For example, the input/output module 106 can leverage the NUI device 110 to perform skeletal mapping along with feature extraction with respect to particular points of a human body (e.g., different skeletal points) to track one or more users (e.g., four users simultaneously) to perform motion analysis. In at least some embodiments, feature extraction refers to the representation of the human body as a set of features that can be tracked to generate input. For example, the skeletal mapping can identify points on a human body that correspond to a left hand 112. The input/output module 106 can then use feature extraction techniques to recognize the points as a left hand and to characterize the points as a feature that can be tracked and used to generate input. Further to at least some embodiments, the NUI device 110 can capture images that can be analyzed by the input/output module 106 to recognize one or more motions and/or positioning of body parts or other objects made by a user, such as what body part is used to make the motion as well as which user made the motion.

In implementations, a variety of different types of gestures may be recognized, such as gestures that are recognized from a single type of input as well as gestures combined with other types of input, e.g., a hand gesture and voice input. Thus, the input/output module 106 can support a variety of different gestures and/or gesturing techniques by recognizing and leveraging a division between inputs. It should be noted that by differentiating between inputs of the NUI device 110, a particular gesture can be interpreted in a variety of different ways when combined with another type of input. For example, although a gesture may be the same, different parameters and/or commands may be indicated when the gesture is combined with different types of inputs. Additionally or alternatively, a sequence in which gestures are received by the NUI device 110 can cause a particular gesture to be interpreted as a different parameter and/or command. For example, a gesture followed in a sequence by other gestures can be interpreted differently than the gesture alone.

The computing device 102 further includes a display device 114, which displays a GUI structure 116 generated and managed according to various techniques discussed herein. The GUI structure 116 includes several related GUIs that a user can navigate and interact with to access functionalities of the applications 104. For example, a user can provide a gesture via the hand 112. The NUI device 110 can detect the gesture and can communicate a description of the gesture to the input/output module 106. The input/output module 106 can interpret the gesture and provide information about the gesture to the user interface module 108. Based on the information about the gesture, the user interface module 108 can cause an interaction with the GUI structure 116. For example, the user interface module 108 can cause a cursor 118 to be visually manipulated on the display device 114 to a portion of the GUI structure 116. As explained in more detail below, a user can provide gestures to access GUIs included as part of the GUI structure 116, and to access functionalities associated with the GUIs.

Having discussed an example environment in which techniques discussed herein can be implemented in accordance with one or more embodiments, consider now a discussion of layered GUI structures.

Layered GUI Structures

In implementations, a layered GUI structure is employed that makes efficient use of available display screen area for GUIs. The layered GUI structure also assists in providing navigation context during a GUI navigation experience. As just a few examples, consider the following implementation scenarios.

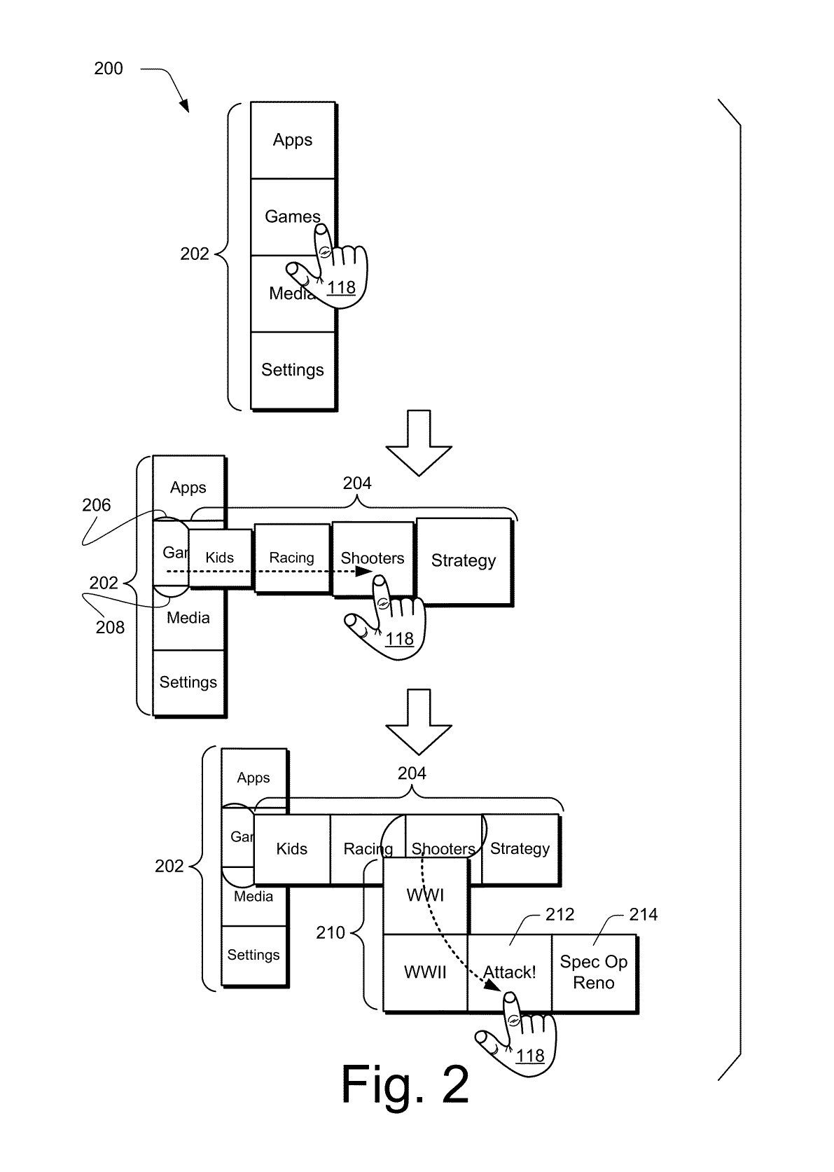

FIG. 2 illustrates an example implementation scenario 200, in accordance with one or more embodiments. Starting with the upper portion of the scenario 200, a GUI 202 is presented that includes a number of selectable options. For example, the GUI 202 includes an “Apps” option that can be selected to navigate to another GUI associated with applications, a “Games” option that can be selected to navigate to another GUI associated with games, and so on. Further to the scenario 200, a user manipulates the cursor 118 to the portion of the GUI 202 associated with the “Games” option. For example, the cursor 118 can be manipulated in response to touchless input, such as input received by the NUI device 110. The cursor 118 can also be manipulated in response to other types of input, examples of which are discussed above.

Continuing to the center portion of the scenario 200, the user selects the “Games” option from the GUI 202. In implementations, an option from the GUI 202 can be selected by manipulating a cursor 118 via a particular gesture with reference to an option to be selected. For example, the “Games” option can be selected by manipulating the cursor 118 into a visual plane occupied by the “Games” option (e.g., “pressing” the “Games” option with the cursor 118), such as by movement of a user's hand towards the NUI device 110 while the cursor 118 is over the “Games” option. Alternatively or additionally, a particular option can be selected by making a particular motion with the cursor 118, such as a circular motion within an option to be selected.

In response to the selection of the “Games” option, a GUI 204 is presented. The GUI 204 represents a sub-menu associated with the selected “Games” option, and includes a number of selectable game category options. As illustrated, presenting the GUI 204 includes animating portions of the GUI 204 out from a lower visual z-order to a higher visual z-order. Thus, the selectable options included as part of the GUI 204 appear to “pop out” from the screen from a smaller size to a larger size to form the GUI 204. This visual animation serves to reinforce the three-dimensional aspect of the GUI structure, as well as provide navigation order context for user.

The GUI 204 is presented as a visual overlay on top of a portion of the GUI 202. For example, the GUI 204 can be displayed such that it has a higher visual z-order than the GUI 202. Thus, a user can navigate and select various options of the GUI 204, while being presented with a visual indication of a GUI navigation context. Further, utilizing different z-orders for different GUIs can enable an entire display area to be utilized for new GUIs that are to be presented. This can provided enhanced freedom for determining where a GUI is to be presented and how the GUI is to be visually configured.

The GUI 204 is visually associated with the GUI 202 via connection indicia 206, 208. In implementations, the connection indicia 206, 208 can provide a visual indication of a relationship between the GUI 204 and the GUI 202. For example, the connection indicia 206, 208 can provide a visual indication that the GUI 204 is a sub-menu of the “Games” option.

Further to the scenario 200, when the GUI 204 is presented, the GUI 202 is visually reduced in size. This can serve as a visual indication that the GUI 204 is currently in focus and can reduce the amount of display screen area taken up by the GUI 202. Visually reducing the size of a previously-navigated GUI can also emphasize the three-dimensional visual aspect of a GUI structure and emphasize a navigation order of GUIs. For example, GUIs can be visually sized according to their navigation order during a GUI navigation experience. A current GUI can be displayed as being larger, with previous GUIs being displayed as increasingly smaller as the GUIs go further backward through the GUI navigation experience. Additionally or alternatively, the GUI 202 can be visually obscured to indicate that it is not currently in focus, such as by visually blurring the lines and/or text of the GUI 202.

Proceeding to the bottom portion of the scenario 200, the user selects a “Shooters” option from the GUI 204. In response, a GUI 210 is presented which includes a number of different selectable options associated with the “Shooters” game option. The GUI 210 is displayed as an overlay on a portion of the GUI 204. Further, the GUIs 204, 202 are visually reduced in size to emphasize that the GUI 210 is currently in focus. In implementations, the visual presentation of the GUIs 202, 204, 210 indicates a hierarchical relationship between the GUIs. For example, the visual presentation can indicate that the GUI 204 is a sub-menu of the GUI 202, and that the GUI 210 is a sub-menu of the GUI 204.

As illustrated, the GUI 210 is displayed in a visually non-linear manner. For example, instead of displaying its selectable options in a linear manner as illustrated with reference to GUIs 202, 204, selectable options included as part of the GUI 210 are displayed according to a variable visual layout. For instance, selectable options 212, 214 are displayed next to other selectable options of the GUI 210. In implementations, enabling a GUI to be displayed according to a visually variable layout can enable the GUI to be displayed on different display screen sizes and/or configurations.

Continuing with the scenario 200, the user manipulates the cursor 118 and selects the selectable option 212. Selecting the selectable option 212 enables a user to access functionality associated with the selectable option, such as launching a game application.

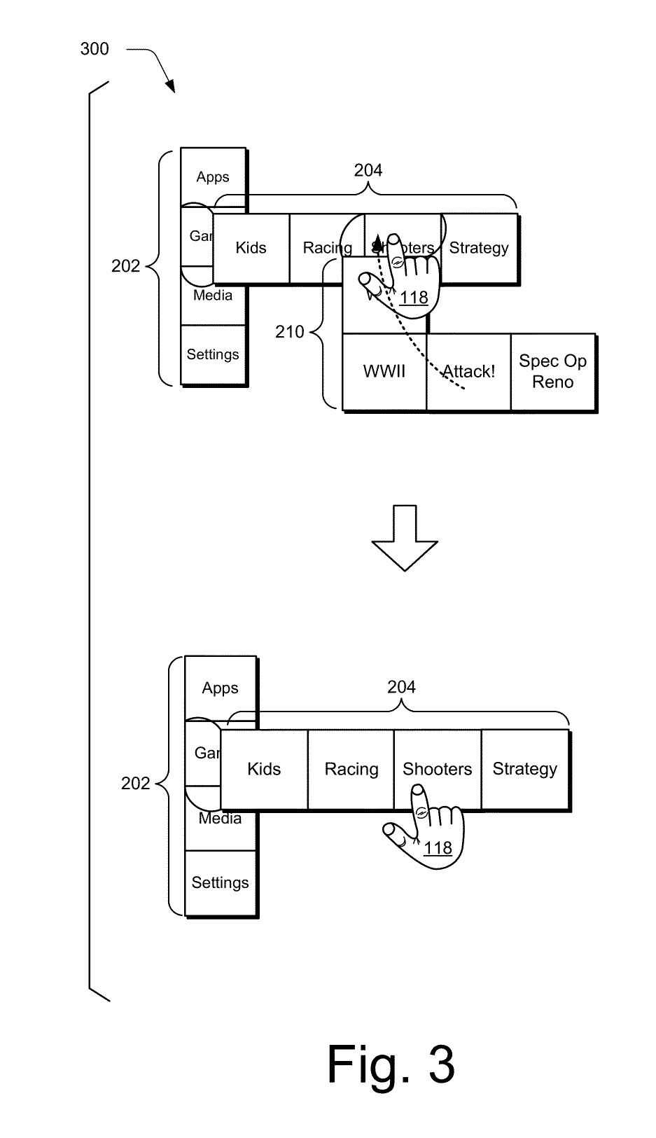

FIG. 3 illustrates an example implementation scenario 300, in accordance with one or more embodiments. The scenario 300 illustrates an example implementation in which a user can navigate backward through a GUI structure. Starting with the upper portion of the scenario 300, a user manipulates the cursor 118 from the GUI 210 to the GUI 204. Continuing to the lower portion of the scenario 300, this manipulation causes the GUI 210 to be removed from display and the GUI 204 to come into focus. For example, the GUI 204 can be expanded in size visually to indicate that the GUI 204 is now in focus. In implementations, the GUI 202 can also be expanded in size relative to the visual expansion of the GUI 204.

While not expressly illustrated here, a GUI and/or GUI structure can be collapsed (e.g., removed from display) by moving a cursor away from the GUI and/or GUI structure. For example, with reference to the lower portion of the scenario 300, a user can cause the GUIs 204, 202 to be collapsed by manipulating the cursor 118 out of the GUI 204. For instance, the user can manipulate the cursor 118 upward or downward such that the cursor exits a border of the GUI 204, thus causing the GUI 204, and optionally the GUI 202, to be removed from display. Thus, techniques discussed herein enable forward and backward navigation through GUIs included as part of the GUI structure.

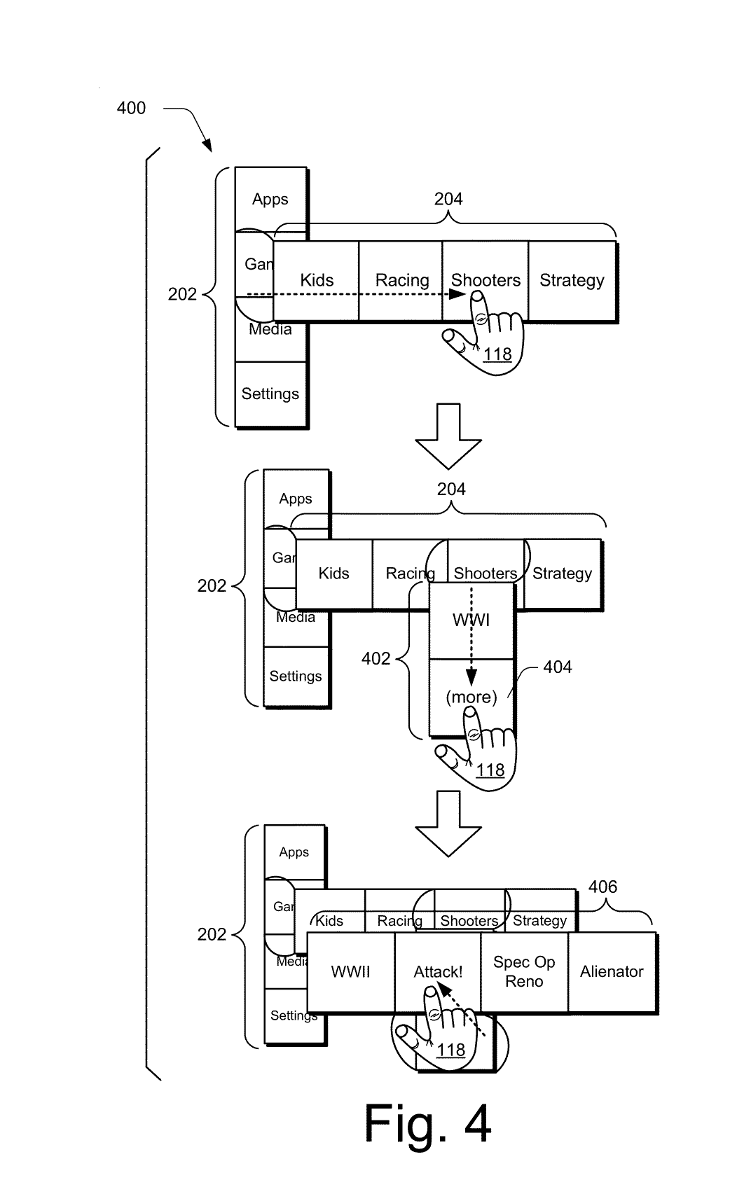

FIG. 4 illustrates an example implementation scenario 400, in accordance with one or more embodiments. Starting with the upper portion of the scenario 400, a user navigates to the GUI 204 and selects a “Shooters” option, as discussed above. Continuing to the center portion of the scenario 400 and in response to the selection, a GUI 402 is presented. The GUI 402 includes a “more” option 404, which serves as a visual placeholder for more selectable options associated with the “Shooters” option.

Further to the scenario 400, the user selects the option 404. Proceeding to the bottom portion of the scenario 400, the selection of the option 404 causes a GUI 406 to be presented. The GUI 406 includes more selectable options associated with the GUI 402. For example, the GUI 402 includes some selectable game options associated with the “Shooters” option, and the GUI 406 includes more selectable game options associated with the “Shooters” option. Thus, providing such a placeholder option in a GUI can enable display screen area to be conserved by providing a visual indication that additional selectable options are available to be viewed. If a user wishes to view the additional selectable options, the user can proceed with selecting the placeholder option to cause the additional selectable options to be displayed.

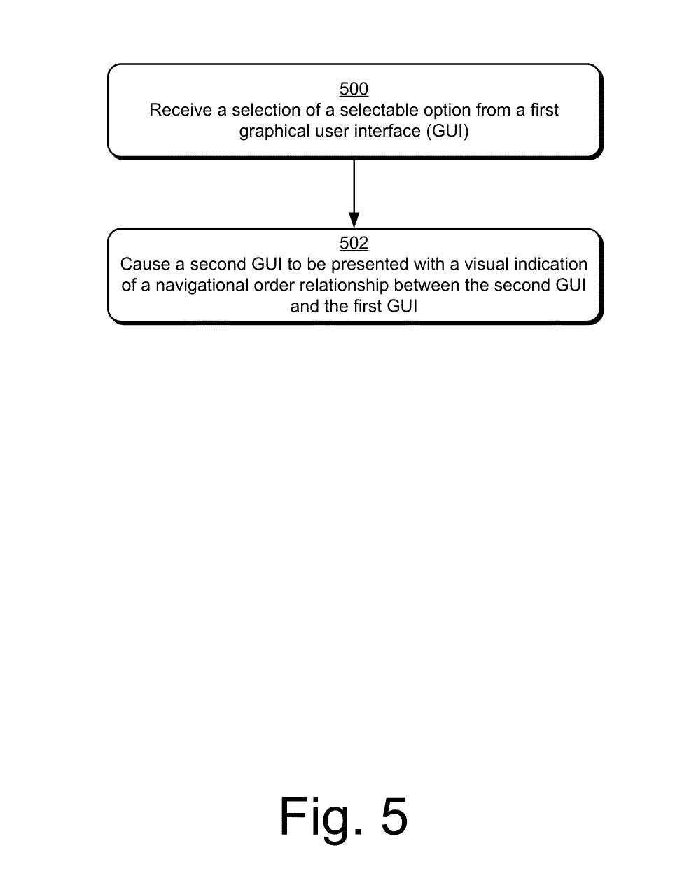

FIG. 5 is a flow diagram that describes steps in a method in accordance with one or more embodiments. Step 500 receives a selection of a selectable option from a first graphical user interface (GUI). As discussed above and below, the selection can be received via touchless and/or touch-based input.

Step 502 causes a second GUI to be presented with a visual indication of a navigational order relationship between the second GUI and the first GUI. For instance, the second GUI can be presented in response to the selection of the selectable option from the first GUI. Examples of such a visual indication are discussed above, such as overlaying a portion of one GUI over a portion of another GUI, displaying connection indicia between one GUI and another GUI, visually deemphasizing a GUI that is earlier in a navigational order (e.g., by decreasing its size and/or visually blurring the GUI), and so on.

In embodiments, a way in which the second GUI is presented can be based on a size of a display area available to present the GUI. For example, if the display area is large enough to accommodate the entire GUI, then the entire GUI can be presented, e.g., in response to the selection of the selectable option from the first GUI. If the display area is not large enough to accommodate the entire GUI, however, a portion of the GUI can be presented with a placeholder that indicates that an additional portion of the GUI is available to be displayed. Examples of such embodiments are discussed above.

In embodiments, a way in which the second GUI is presented can be based on a location of a different GUI on a display area and/or available “clear” display area. For example, if a different GUI is displayed in a portion of a display area, the second GUI can be displayed in another portion of the display area such that the second GUI does not visually obscure all or part of the different GUI. Further, if there is an available clear portion of the display area (e.g., a portion with no displayed GUIs or active display items), all or part of the second GUI can be displayed in the clear portion. Thus, GUI presentation can optimize display area usage by considering clear display area and/or other displayed GUIs when determining where to display a particular GUI.

Having discussed example layered GUI structures in accordance with one or more embodiments, consider now a discussion of gesture-based GUI navigation.

Gesture-Based GUI Navigation

In implementations, gesture-based GUI navigation is employed to provide simplified and intuitive ways for navigating among GUIs. As just a few examples, consider the following implementation scenarios.

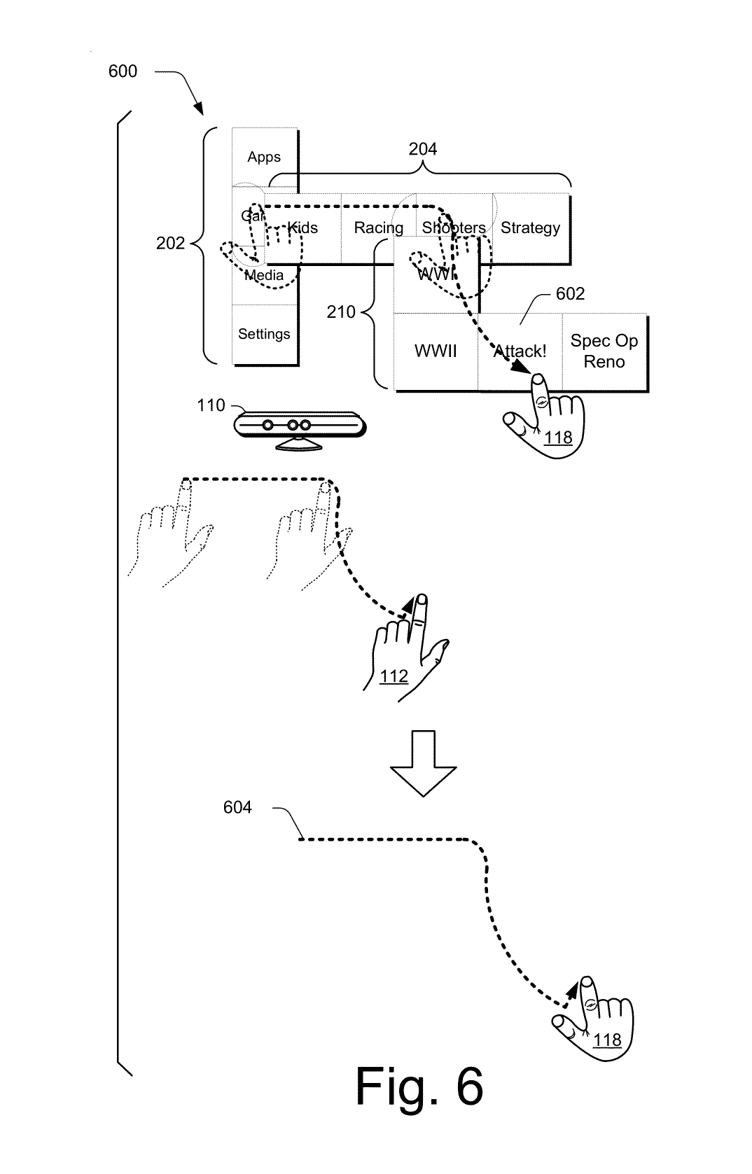

FIG. 6 illustrates an example implementation scenario 600, in accordance with one or more embodiments. Starting with the upper portion of the scenario 600, a user manipulates a cursor 118 among the GUIs 202, 204, and 210 and selects a selectable option 602. As indicated in the middle portion of the scenario 600, the manipulation of the cursor 118 is in response to a gesture provided by the user's hand 112 that are recognized by the NUI device 110. One example of such navigation and selection is discussed above with reference to FIG. 2.

Continuing to the bottom portion of the scenario 600, the manipulation of the cursor 118 to the selectable option 602 can be characterized as a gesture 604. For example, the gesture 604 can be associated with a navigation through the GUIs 202, 204, 210 such that when a user provides the gesture 604 (e.g., via touchless and/or touch-based input), navigation through the GUIs 202, 204, 210 to the selectable option 602 automatically occurs. In implementations, the gesture 604 is provided as a continuous gesture. For example, the user provides the gesture 604 from beginning to end by moving the user's hand 112 in a continuous motion without pausing or stopping.

Alternatively or additionally, the gesture 604 can be associated with a selection of the selectable option 602 such that when a user provides the gesture 604 (e.g., via touchless and/or touch-based input), a functionality associated with the selectable option 602 is invoked. In implementations, the functionality can include a presentation of and/or navigation to another GUI, launching an application, navigating to a website or other network location, opening a file and/or file folder, and so on.

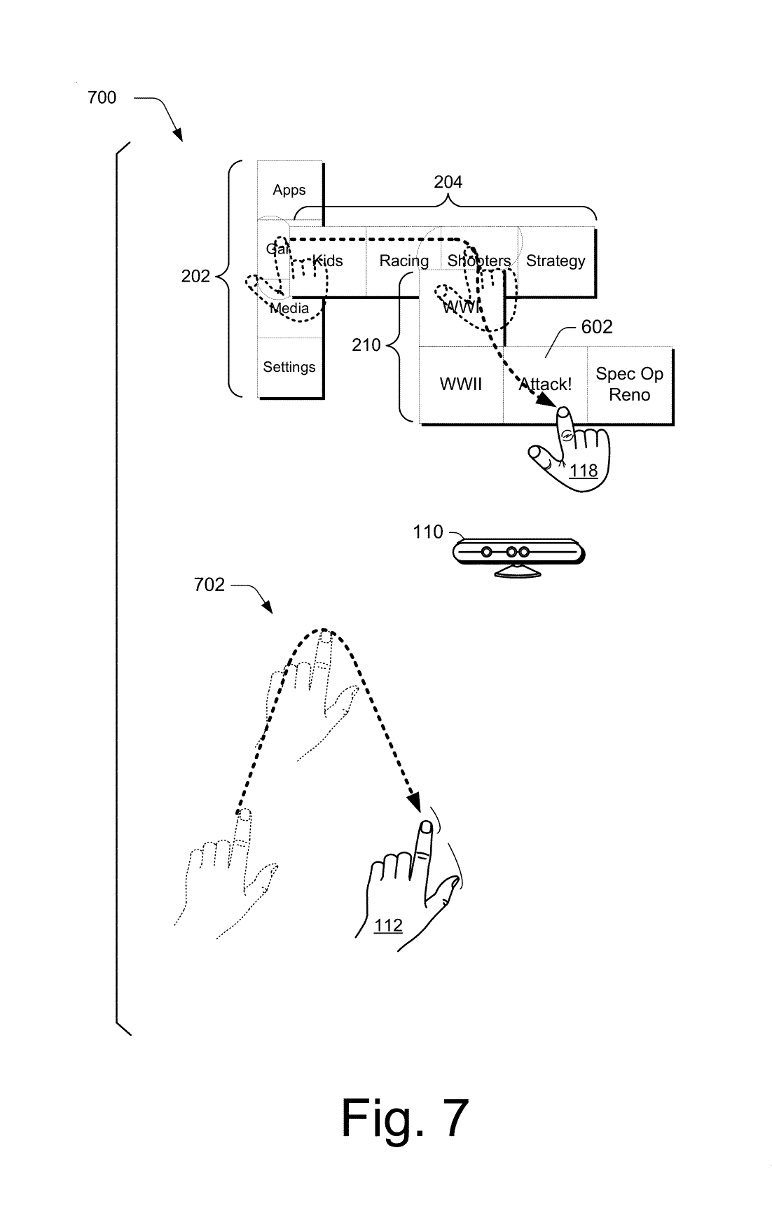

FIG. 7 illustrates an example implementation scenario 700, in accordance with one or more embodiments. As part of the scenario 700, a user provides a gesture 702 via the user's hand 112, which is detected by the NUI device 110. The user associates the gesture 702 with navigation through the GUIs 202, 204, 210 such that when a user subsequently provides the gesture 702 (e.g., via touchless and/or touch-based input), navigation through the GUIs 202, 204, 210 to the selectable option 602 automatically occurs.

For example, the user can invoke a functionality that enables custom gestures to be associated with selections of selectable options. Such functionality can be implemented as part of the applications 104, the input/output module 106, the user interface module 108, and so on. For example, a user can invoke the functionality using a voice command (e.g., “recognize gesture), and can provide a particular gesture to be recognized and associated with a selection of a selectable option and/or invocation of a functionality. Thus, a user can specify that when a particular gesture is provided, navigation through multiple GUIs to a particular GUI and/or selectable option is to automatically occur.

Alternatively or additionally, a custom gesture can be associated with a selectable option such that when the gesture is provided, a particular selectable option is to be selected and/or a particular functionality is to be invoked. In implementations, a custom gesture can be arbitrarily specified (e.g., by a developer, a user, and so on) and may be independent of (e.g., not associated with) a visual navigation among GUIs in a GUI structure. For example, a custom gesture can be such that, were it not expressly specified as being associated with a selectable option, it would not cause navigation to and/or a selection of the selectable option.

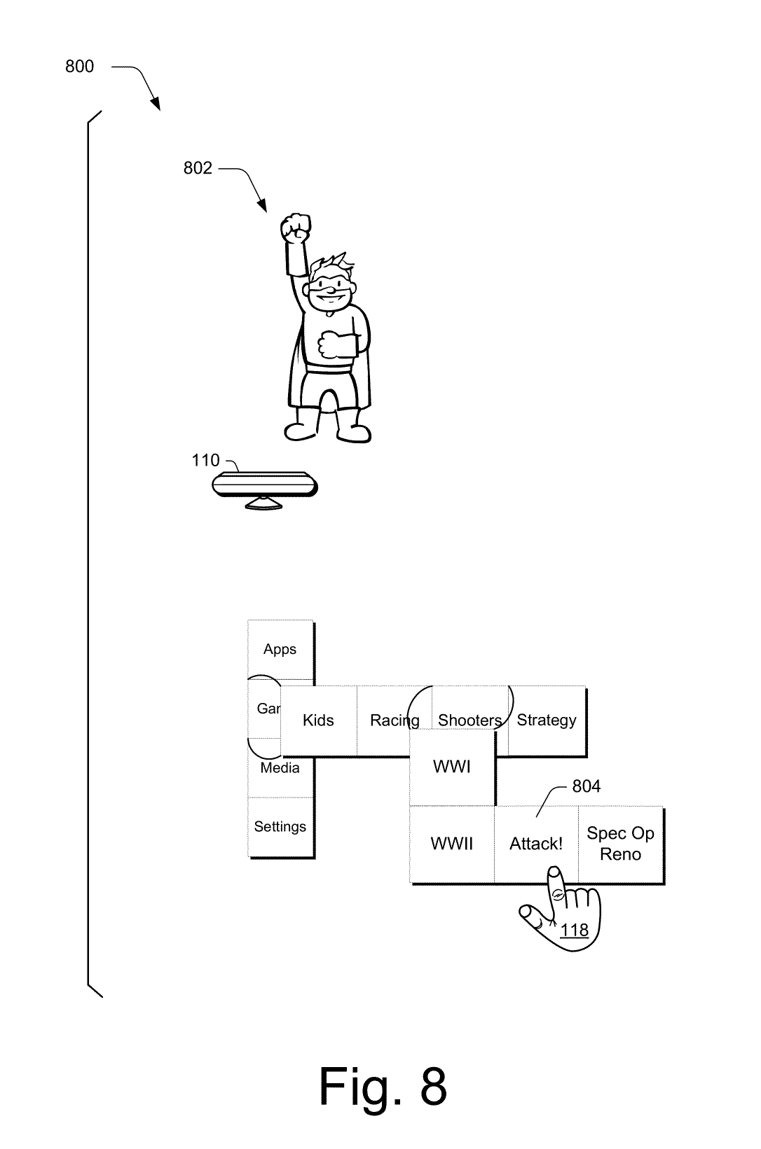

FIG. 8 illustrates an example implementation scenario 800, in accordance with one or more embodiments. As part of the scenario 800, a user provides a pose 802, which is detected by the NUI device 110. In implementations, a pose can correspond to particular positions of multiple portions of a human body. Further, a pose can correspond to static positions of portions of a human body, and/or can correspond to movement of portions of the human body between different positions.

Further to the scenario 800, the user associates the pose 802 with a selection of a selectable option 804. For example, the user can invoke a functionality that enables custom poses to be associated with selections of selectable options. Such functionality can be implemented as part of the applications 104, the input/output module 106, the user interface module 108, and so on. Thus, a user can specify that when a particular pose is provided, a particular selectable option is to be selected and/or a particular functionality is to be invoked.

In implementations, combinations of gestures and poses can be specified (e.g., by developers, end-users, and so on) to invoke selectable options and/or functionalities. For example, a user can strike a particular pose and provide a particular hand gesture to invoke a selectable option. Further, other types of input can be combined with gestures and/or poses to invoke functionalities. For example, a user can invoke a menu GUI using a voice command specific to the GUI. The user can select a selectable option associated with the menu GUI by providing a particular gesture and/or pose that is associated with the selectable option.

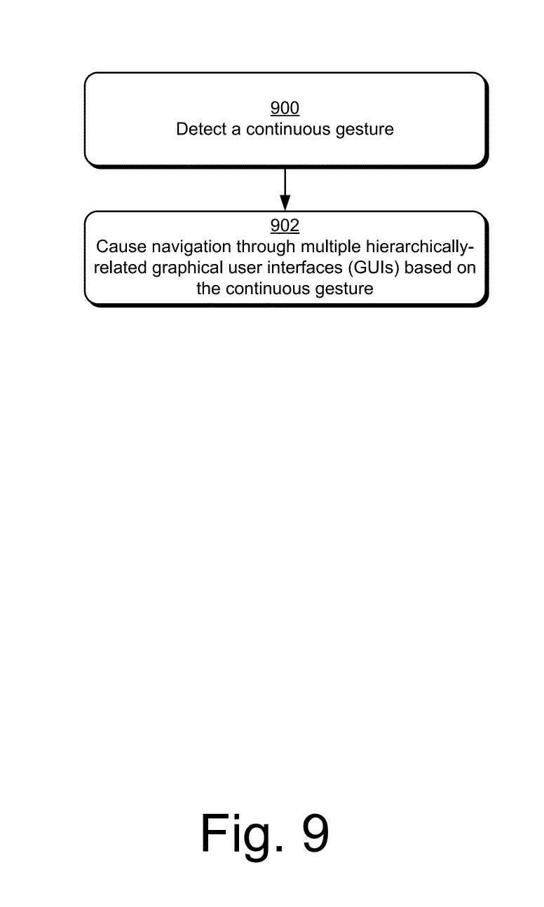

FIG. 9 is a flow diagram that describes steps in a method in accordance with one or more embodiments. Step 900 detects a continuous gesture. As discussed above, a continuous gesture can refer to a gesture (e.g., a touchless and/or touch-based gesture) detected as a continuous motion without pausing or stopping during the gesture.

Step 902 causes navigation through multiple hierarchically-related GUIs based on the continuous gesture. For example, the navigation can be from one GUI to one or more sub-GUIs (e.g., sub-menus) in response to the continuous gesture.

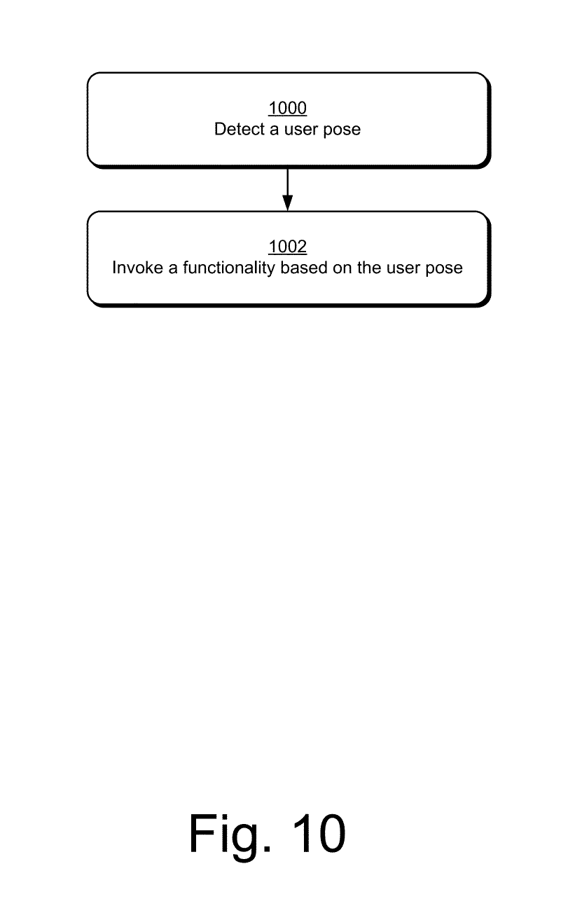

FIG. 10 is a flow diagram that describes steps in a method in accordance with one or more embodiments. Step 1000 detects a user pose. As mentioned above, a pose can correspond to particular positions of multiple portions of a human body detected via a touchless mechanism, e.g., via the NUI device 110. Step 1002 invokes a functionality based on the user pose. For example, the functionality can include navigation through multiple different GUIs, navigation to a particular GUI, an application, and so on. As mentioned above, a pose can also be combined with one or more gestures to invoke a functionality. In at least some embodiments, custom poses can be specified (e.g., by a developer, a user, and so on) to invoke particular functionalities.

Example System and Device

FIG. 11 illustrates an example system generally at 1100 that includes an example computing device 1102 that is representative of one or more computing systems and/or devices that may implement various techniques described herein. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more I/O Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media does not include signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules as an module that is executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. This is illustrated through inclusion of the user interface module 108 on the computing device 1102. The functionality of the user interface module 108 and other modules may also be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Conclusion

Techniques for providing a visual indication of GUI relationship are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method, comprising:
receiving a selection of a selectable option from a first graphical user interface (GUI); and
causing, in response to the selection, a second GUI to be presented with a visual indication of a navigational order relationship between the second GUI and the first GUI.

2. A method as described in claim 1, wherein the selection is received in response to a touchless gesture detected by one or more cameras.

3. A method as described in claim 1, wherein the visual indication comprises overlaying at least a portion of the second GUI over a portion of the first GUI associated with the selectable option.

4. A method as described in claim 1, wherein the visual indication comprises at least one of reducing a size of the first GUI or visually blurring at least a portion of the first GUI.

5. A method as described in claim 1, wherein the visual indication comprises at least one connection indicia connecting the first GUI to the second GUI.

6. A method as described in claim 1, wherein the visual indication comprises an indication of a hierarchical relationship between the first GUI and the second GUI.

7. A method as described in claim 1, wherein said causing comprises causing the second GUI to be presented with a variable visual layout that is based at least in part on a size of a display screen on which the second GUI is to be displayed.

8. A method as described in claim 1, wherein the selectable option comprises a placeholder indicating that one or more additional selectable options are available for the first GUI, and wherein the second GUI includes the one or more additional selectable options.

9. One or more computer storage media storing computer-executable instructions, the computer-executable instructions comprising at least one module configured to, when executed:
receive an indication of a navigation among multiple graphical user interfaces (GUIs) in response to detection of at least one of a gesture or a pose; and
present the multiple GUIs with at least one visual indication of a navigational order relationship between the multiple GUIs.

10. One or more computer storage media as described in claim 9, wherein the pose comprises positions of multiple portions of a human body.

11. One or more computer storage media as described in claim 9, wherein the detection comprises detection of a combination of the gesture and the pose.

12. One or more computer storage media as described in claim 9, wherein at least one of the gesture or the pose is pre-specified to cause the navigation among the multiple GUIs.

13. One or more computer storage media as described in claim 9, wherein at least one of the gesture or the pose is pre-specified to automatically launch an application associated with at least one of the multiple GUIs.

14. One or more computer storage media as described in claim 9, wherein the visual indication comprises resizing at least one of the GUIs based on its position in the navigational order relationship.

15. One or more computer storage media as described in claim 9, wherein the at least one module is further configured to, when executed, automatically invoke a functionality associated with one of the multiple GUIs in response to the detection.

16. One or more computer storage media as described in claim 9, wherein the at least one module is further configured to, when executed, cause at least one of the GUIs to be removed from display in response to detection of a different gesture away from the at least one of the GUIs.

17. A computer-implemented method comprising:
detecting a continuous gesture; and
causing navigation through multiple hierarchically-related graphical user interfaces (GUIs) in response to the continuous gesture.

18. A computer-implemented method as described in claim 17, wherein the continuous gesture comprises a gesture detected as a continuous motion without pausing or stopping during the gesture.

19. A computer-implemented method as described in claim 17, wherein said causing comprises causing the GUIs to be presented with at least one visual indication of a navigation order for the GUIs.

20. A computer-implemented method as described in claim 17, wherein the continuous gesture comprises a user-specified custom gesture.
